(19) United States
(12) Patent Application Publication
(10) Pub. No.: US 2006/0229909 A1
(43) Pub. Date: Oct. 12, 2006

(54) Lifecharts medical information system

(76) Inventors: Sanjeev Kaila, Samia (CA); Rajeev Kaila, Lawrenceville, GA (US)

Correspondence Address: HARNESS, DICKEY & PIERCE, P.L.C., P.O. BOX 828, BLOOMFIELD HILLS, MI, 48303, US

(21) Appl. No.: 11/100,331

(22) Filed: Apr. 6, 2005

(51) Int. Cl. G06Q 10/00

(52) U.S. Cl. 705/2

(57) ABSTRACT

The medical information system allows users to store pertinent medical information in a web-enabled data store that can be accessed from anywhere in the world using a web browser, provided the user's unique account number is ascertained and entered. The system allows the user to print a medical card containing the account number. Any suitable printer connected to the user's computers may serve this purpose. All data are maintained in an encrypted format and the system is further secured by separating the person's medical history from his or her personal information, such as name, address and credit card information. The medical information and personal information are stored in separate data stores, administered by separate systems, to significantly reduce the chances of a person's medical history being inadvertently disclosed to an unauthorized third party.

### FIELD OF THE INVENTION

The present invention relates generally to medical information systems. More particularly, the invention relates to an internet-based medical information system.

### BACKGROUND

Despite the advances made in the medical profession, generally, the field of emergency medical record keeping is in shambles. The problem is perhaps most acute in the emergency room or emergency clinic, where an unconscious patient or child patient is wheeled in without any quick and effective way of acquiring that patient's critical medical records. Emergency room physicians understandably desire information about whether the patient has any drug allergies or other medical conditions that might dictate one particular form of treatment over others. However, unless the patient is lucid and knows this information, the emergency room doctors are left using their own best judgment, based on reasonable assumptions that may not, in fact, be fully accurate. Even in the situation where the patient is lucid, many patients do not adequately recall their specific medical history and cannot remember details sufficiently when stressed. The fault lies in today's emergency record keeping systems, which are simply not up to the task of cohesively assembling, maintaining, prioritizing, and providing emergency medical information. Also, most of this information is taken while the patient is sick and stressed, leading to inaccurate information. It is much better to accumulate this information when the patient is calm, healthy, and rational, and this accumulation is best performed over time with the aid of their own doctor.

Medical record systems, in general, are challenged in several respects. First, most patients regard their medical history as confidential, and in most countries, there are numerous regulations that require medical records to be maintained in a confidential manner. Thus an effective medical record keeping system needs to respect this need for confidentiality.

To further complicate matters, a patient's medical records will rarely be collected all in one place. More commonly, such records will be “distributed” across the record keeping systems of numerous different medical service providers. For example, a patient's primary care physician may maintain one set of medical records; the patient's dentist or allergist may maintain separate sets of records, and these separate sets of records are rarely integrated. Of course, not all of a patient's medical history will necessarily be relevant in an emergency situation. However, there has not heretofore been any workable solution for how to separate out the relevant medical records and make those records available in an emergency.

Indeed, all individuals need to maintain good medical records, for use in times of emergency. Parents need to maintain such records, not only for themselves, but for their children. Unfortunately, the medical record keeping art has not heretofore provided a workable solution that will allow the average person to generate and maintain an emergency medical record database for himself and his family.

### SUMMARY OF THE INVENTION

The system allows enrollees or other types of enrollees to store key medical information in a secure manner, and yet in a manner that will allow medical personnel to access and view that information by entering a unique account number associated with that enrollee into a web-based system. Notably, the system employs a simple to use card, tag or other device kept on the enrollee's person. The card, tag or device carries the URL of an information server in the web-based medical system as well as the enrollee's unique account number. The card may be conveniently printed by the enrollee, in his or her home or office, using a suitable printer attached to the enrollee's computer. Alternatively, the patient who does not wish to print their own card may request the delivery of one to them. In one embodiment the medical information system may be further linked to one or more medical care service providers to allow the enrollee to update his or her medical records by accessing the provided medical service provider records.

For a more complete understanding of the invention, its objects and advantages, refer to the remaining specification and to the accompanying drawings.

### BRIEF DESCRIPTION OF THE DRAWINGS

The present invention will become more fully understood from the detailed description and the accompanying drawings, wherein:

FIG. 1 is an interaction diagram illustrating the communication of messages and information among entities within the information system to enroll a patient in the medical information system;

FIG. 2 is an interaction diagram illustrating the messages and information passed among systems to access medical information;

FIG. 3 is a hardware system block diagram illustrating the configuration of the medical information system;

FIG. 4 is an interaction diagram illustrating how medical information can be updated or revised by the enrollee;

FIG. 5 is a hardware system diagram illustrating an embodiment where the information system is coupled to a medical service provider system; and

FIGS. 6-50 are diagrams illustrating components of a user interface according to the present invention.

### DETAILED DESCRIPTION OF THE PREFERRED EMBODIMENTS

The following description of the preferred embodiment(s) is merely exemplary in nature and is in no way intended to limit the invention, its application, or uses.

The present invention seeks to rectify the many deficiencies in current medical record keeping by providing a web-based medical record system that is ideally suited for storing medical information for use in times of emergency. The system implements a medical records database with which enrolled patients and emergency room personnel can readily communicate in a secure fashion, using a common web browser. The system prompts the enrollee to provide answers to key questions from which a comprehensive emergency medical history is generated.

To ensure confidentiality of these records is maintained, the preferred system uses a medical information database that stores each enrollee's medical records in association with a unique account number. However, information identifying the enrollee's name, address, credit card information, and the like, are not stored in this database. Rather, the enrollee's personal information, such as name, address, credit card numbers, and the like, are stored separately in a private information data center. The private information data center does not store the medical records of that enrollee. The medical information database and the personal information database integrate with one another through a common shared key or link comprising the unique account number. Both databases are encrypted, as well. Thus anyone gaining access to the medical information database would first have to determine how to decrypt the files stored therein, and, after decrypting them (if even possible), all such an interloper would find would be sets of medical records associated with account numbers. Because no personal information is stored in those databases, the interloper would not be able to associate any one of the medical histories with a particular enrollees identity.

The medical records system also features a convenient, enrollee printed card that contains the information needed to obtain emergency medical information. Specifically, after the enrollee has entered information into the database, the web-based system supplies the enrollee with a web screen in the form of a wallet-sized card. The card contains the enrollee's name, a enrollee-selected “username”, and the enrollee's unique account number that is issued by the system. The card also contains the website address or URL of the medical records system. The card may be printed on any convenient printer attached to the user's computer. If the card is lost, additional copies can readily be printed. As well as printing, the option of having a hard, tag-like device or card-like device mailed to them is given to the client, as many clients may not suitably carry a card in their wallet.

In an emergency situation, the emergency care nurse or physician discovers the card in the enrollee's wallet (or discovers a physical tag bearing the same information worn on the enrollee's person) and then uses the information printed thereon to access the enrollee's medical history. Specifically, the emergency room nurse or physician would log onto the URL specified and enter the account number printed on the card or tag. Although the enrollee's true first and last name are printed on the card, it will be recalled that this information is not stored in the medical history database. Thus the account number is used to retrieve the enrollee's medical history.

In the preferred system the enrollee (or parent, if the enrollee is a minor) enters the medical history into the system by answering a series of preconfigured questions. These questions are designed by medical experts to elicit useful medical information in an unambiguous way. In one alternate embodiment, the medical information system may be coupled to the system of a medical service provider through a suitable middleware interface. This coupling allows the enrollee to access selected portions of his or her medical information being maintained by a medical service provider, such as the enrollee's primary care physician.

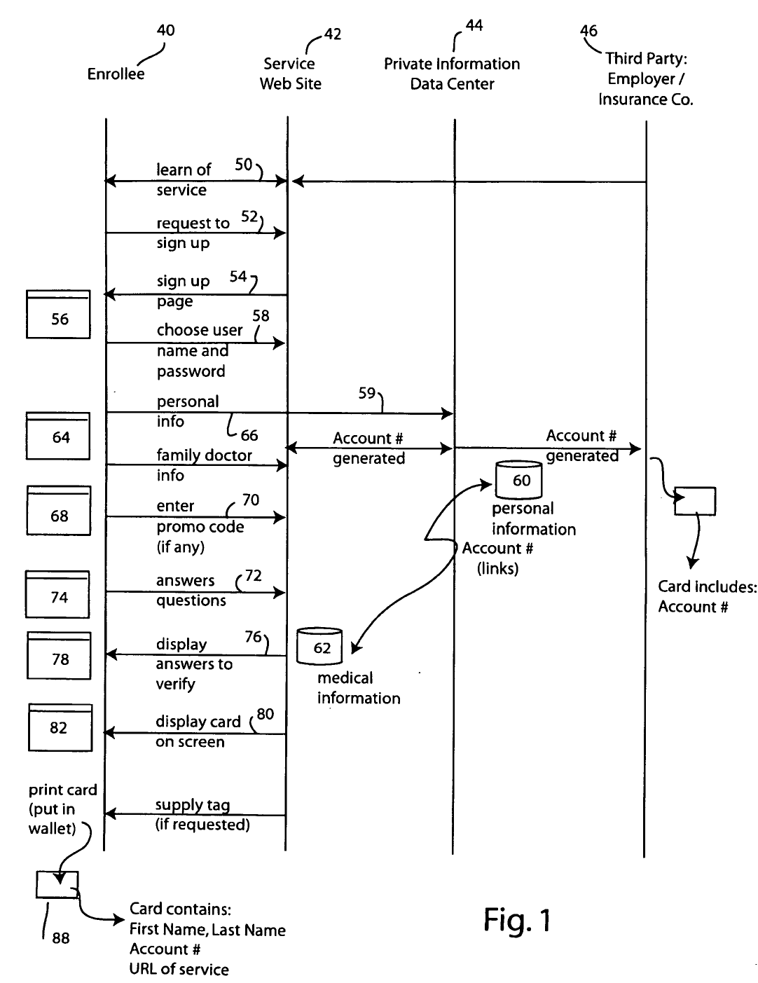

FIG. 1 illustrates the key entities involved, or potentially involved, in the medical information system. These entities include the subscribing enrollee 40 whose medical records will be stored in the system, a service website entity 42 that handles the primary interactions between the person during enrollment and other parties accessing the medical information during subsequent use. The system also utilizes a private information data center 44 where personal information is stored. Finally, FIG. 1 illustrates an optional third party entity 46 that may have some involvement in the overall operation of the system. Examples of such third parties include employers, insurance companies, governmental agencies, and the like.

FIG. 1 illustrates a sequence of messages that are communicated among the illustrated entities in order to enroll a person in the medical record system and to provide the enrollee with a card for his or her wallet (or an alternate device such as a tag). Beginning at 50, the enrollee learns of the medical record service through advertising or possibly from a third party. In this regard, the enrollee may be employed with a company that offers the medical record service to all of its employees. In such case, the enrollee 40 can learn about the service from his or her employer. Alternately, the person's insurance company might offer medical record services and can, in that case, notify enrollee 40 of the service.

At 52, the enrollee accesses website 42 to request more information and to sign up for the service. At 54, the website supplies the enrollee with a signup webpage 56 which provides fields into which the enrollee supplies requested information. Specifically, the enrollee is asked to choose a username and a password. These are used in connection with other, later-described aspects of the system where the enrollee wishes to change information in the database. After selecting a username and a password, at 58, the system then prompts the enrollee to supply personal information, such as the enrollee's name, address, credit card number, social security number, and/or other information identifying the enrollee. This information is sent to the private information data center 44 where it is stored in a data store 60 of personal information. At this time, the system generates a unique account number that will thereafter be associated with the individual enrollee 40. The account number may be generated at either the service website of the private information data center, depending on the architectural design of the system. The account number is communicated to both systems, so that the service website and the private information data center both have the generated account number. The account number is associated with the enrollee's personal information within data store 60, and it is also associated with a medical information data store 62 maintained by the service website 42. The account number thus serves as a link or database key whereby data stores 60 and 62 are related.

In addition to capturing and storing the enrollee's personal information, the system also prompts the enrollee to supply additional information more pertaining to his or her medical history. Thus, the website presents a web screen 64 into which information such as identity of the enrollee's family doctor is provided to the website 42. Screen 64 may, if desired, be integrated with the screen used to gather the enrollee's personal information that is sent, at 59, to the private information data center 44. The family doctor information, provided at 66, represents a class of information that is stored in the medical information data store 62, as opposed to the personal information data store 60. This choice arises because the information about the person's family doctor may be part of the medical history that an emergency room physician would want to know in case of an emergency. Also, the system may employ an optional screen or question on an existing screen where a promotional code may be entered to identify that enrollee as being eligible to receive different pricing options than other enrollees. Such information may be supplied through web screen 68 and provided as at 70 to the service website.

Next, at 72, a web screen 74, or series of web screens 74, are used to elicit information from the enrollee about his or her medical history. These questions are preferably designed by medical experts to elicit unambiguous and accurate medical information. In a preferred embodiment, each question allows the enrollee to supply an answer (such as the enrollee's blood type) where the answers are chosen from a list of all valid answers. In some embodiments, the questions also give the enrollee an opportunity to say “I don't know.”

The service website 42 then at 76 displays the enrollee's answers on a web screen 78 and requests the enrollee to verify that they are correct. The enrollee can either edit the responses at this point or, if they are correct, request a card to be sent. The web service 42 then generates a medical card at 80 which is displayed on the enrollee's web screen 82 with instructions to the enrollee on how the card may be printed and placed in the enrollee's wallet. If desired, the enrollee can also order an alternate form of medical information tag from the website 42. The alternate form may be more suited for children and persons who regularly do not carry their wallet. The tag may be attached to the enrollee's clothing, to a necklace, bracelet or the like. The printed card (or tag) contain basic information, namely the user's first and last name, username, the unique account number generated by the system as well as the web address or URL of the service website.

Although the user's name appears on the card, that information is not stored in the medical information data store 62. It is, preferably, stored in the personal information data store 60, but that information is not available for viewing when accessing the service website 42.

Once the information has been stored in the system, as described above, it is maintained in an available for access state by anyone, throughout the world, who logs on to the service website using the designated URL and using the username and account number of that person. If the card or tag is ever lost or stolen, the enrollee can log onto the system to have that account number declared invalid and have a new one issued. Otherwise, anyone who is able to obtain the user's card will be able to look up that enrollee's medical history. For more details relating to a preferred embodiment of the account signup, lost card, and forgotten password processes, reference should be taken to Table 1, Table 2, and Table 3, provided immediately below.

TABLE 1
Signing Up For a New Lifecharts Account:

| 1. | Site visitor clicks on “Setup New Account” button | |
|---|---|---|
| 2. | Legal agreement is displayed. | |
| | a. | Client must check a checkbox agreeing to |
| | | the legal agreement, and click on “Continue.” |
| 3. | Client is then asked for their name, mailing address, | |
| | and a valid e-mail. | |
| | a. | Client is prompted to select a username |
| | | and a password. |
| | b. | Client is also asked to select and answer |
| | | two security questions in case they forget |
| | | their password or lose their card in the |
| | | future. |
| 4. | Next, the client is prompted for a “Promotional Coupon | |
| | Code,” which if entered can discount the cost, or | |
| | include a different service, etc. | |
| 5. | Next, the client is asked to enter their billing | |
| | information. This information includes: | |
| | a. | Name on credit card; |
| | b. | Billing address; |
| | c. | Credit card type; |
| | d. | Credit card expiration date; |
| | e. | Credit card #; and |
| | f. | Credit card CVV2 code (3 or 4 digit code |
| | | located on card). |

| | |
|---|---|
| 6. | Next, the client is displayed an order confirmation |
| | screen, where they can confirm their order or change |
| | their mind. |
| 7. | If the order is confirmed, it's processed, a random |
| | account number is generated and the data entered |
| | until this point is stored in its respective database. |
| 8. | Next, the client is asked for his or her family |
| | doctor information, including doctor's name, and |
| | two phone numbers where the doctor can be reached. |
| 9. | Next, the client is asked for two emergency contacts, |
| | who are people who should be contacted if an |
| | emergency occurs. Two phone numbers, and a |
| | relationship are required for each of the emergency |
| | contacts provided. |
| 10. | Next, the client is asked where they heard about |
| | the site. |
| 11. | Next, a temporary copy of their Emergency Medical |
| | Card is displayed. They can print this card out. |
| | They are then given the option of proceeding |
| | directly to the medical questions, or printing |
| | out a “Physician Help Sheet” to get their |
| | family doctor to help them answer the questions. |
| 12. | If they select to go straight to the medical questions, |
| | they then proceed through each medical question in order. |

TABLE 2
Lost Lifecharts Emergency Medical Card:

| | |
|---|---|
| 1. | Client clicks on “Lost Card” link. |
| 2. | Client is prompted to enter their name and e-mail address. |
| | This address is encrypted and used to identify who they |
| | are in the database. |
| 3. | Once they are identified, they are then prompted with the |
| | two security questions that they selected when they |
| | signed up. |
| 4. | If they answer both questions correctly, their account |
| | number is regenerated. |
| 5. | They are then asked to choose a new username. |
| 6. | Their new temporary card is displayed with their new |
| | account number and username. Their old account number is |
| | disabled. |
| 7. | They are given the option of purchasing a new permanent |
| | card for $15. If they choose to do so, they are asked for |
| | credit card information, and their credit card is billed. |

TABLE 3
Forgotten Password in Lifecharts Emergency Medical Card:

| | |
|---|---|
| 1. | Client clicks on “Forgot my password” link. |
| 2. | Client is prompted to enter their name and e-mail address. |
| | This address is encrypted and used to identify who they |
| | are in the database. |
| 3. | Once they are identified, they are then prompted with the |
| | two security questions that they selected when they |
| | signed up. |
| 4. | If they answer both questions correctly, they are then |
| | displayed the last 4 digits of the credit card they used |
| | to sign up with. They are asked to fill in the missing digits. |
| 5. | If they get the credit card # correct, they are allowed |
| | to reset their password on the page. |

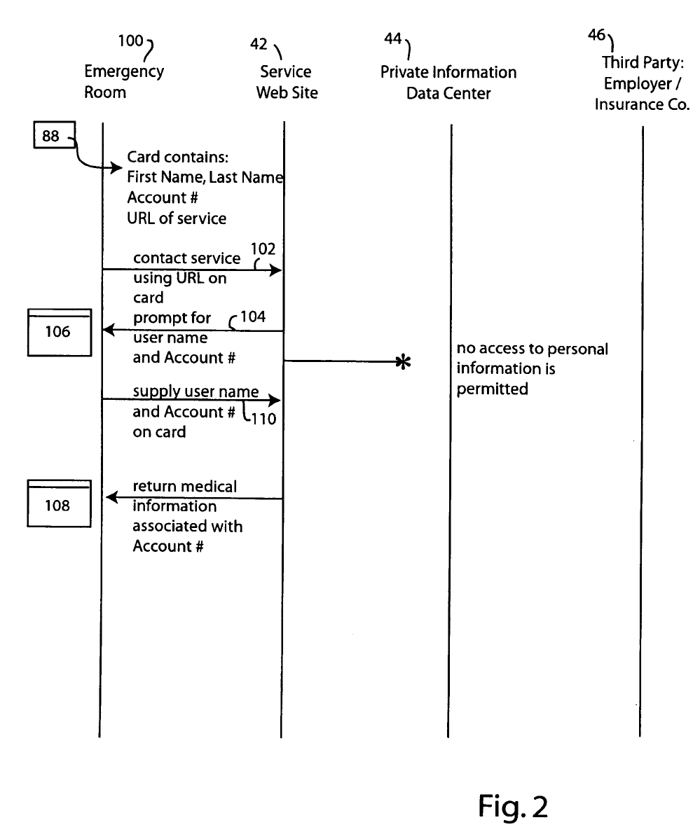

According to the basic premise of the system, the need for access to medical information will likely occur in a medical emergency situation. The process in such an emergency will now be described in connection with FIG. 2.

In FIG. 2, a new entity 100 has been illustrated. This entity is designated in FIG. 2 as “emergency room” but it will be understood that in general, this entity refers to the medical service provider that will be administering emergency medical care. Of course, the same process can be followed by other entities who have access to the enrollee's card (or tag).

The process begins with personnel associated with the emergency room 100 obtaining the medical card 88. By reading the card, emergency room personnel are instructed to log onto the designated URL of the service website 42 and they are then prompted to enter the account number. This process is illustrated at 102 and 104. Such information is preferably communicated using a web screen such as web screen 106. The medical person then responds by supplying the account number at 110. The service website 42 then replies by supplying the enrollee's medical information in a web screen 108.

Note that the interactions illustrated in FIG. 2 do not allow an individual in possession of the card 88 to access the enrollee's private information.

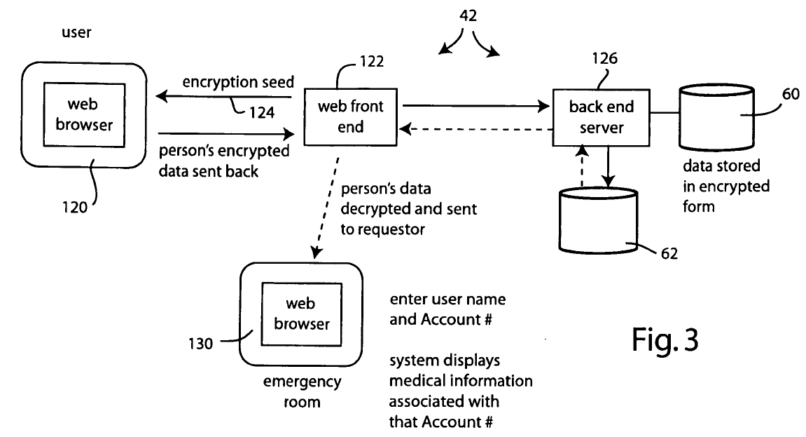

To ensure the confidentiality of the enrollee's medical information and personal information, the preferred embodiment utilizes encryption technology. Referring to FIG. 3, in a presently preferred implementation, the enrollee provides information to the system using a web browser 120 which communicates with the web front end server 122 of the service website 42. The web front end server 122 may be configured to serve HTML pages to the web browser 120, with embedded PHP statements to support the enrollee interaction. The web front end effects encryption by sending an encryption seed to the web browser as at 124. The encryption seed is then used to generate an encryption key that is used to encrypt the information sent from the web browser to the web front end 122. Thus, information communicated over the internet between web browser 120 and web front end 122 are encrypted.

The web front end 122 then conveys the information to the back end server 126, which stores the received information (still in encrypted form) in the personal information data store 60 and the medical information data store 62. The back end server routes the incoming information to the proper data store automatically.

Later, when an emergency room need for information arises, a web browser 30 in the emergency room is used to log onto the service website 42 and request medical information. Specifically, the emergency room web browser supplies the account number to the front end server 22 and the front end server then requests the back end server 126 to obtain the information from data store 62 and supply it back to the emergency personnel. Because the information is stored in an encrypted form within data store 62, it must be decrypted first. This is done by either decrypting it at the web front end 122 or by passing a suitable decryption key to the web browser 130 to allow the web browser to decrypt the information at the browser side.

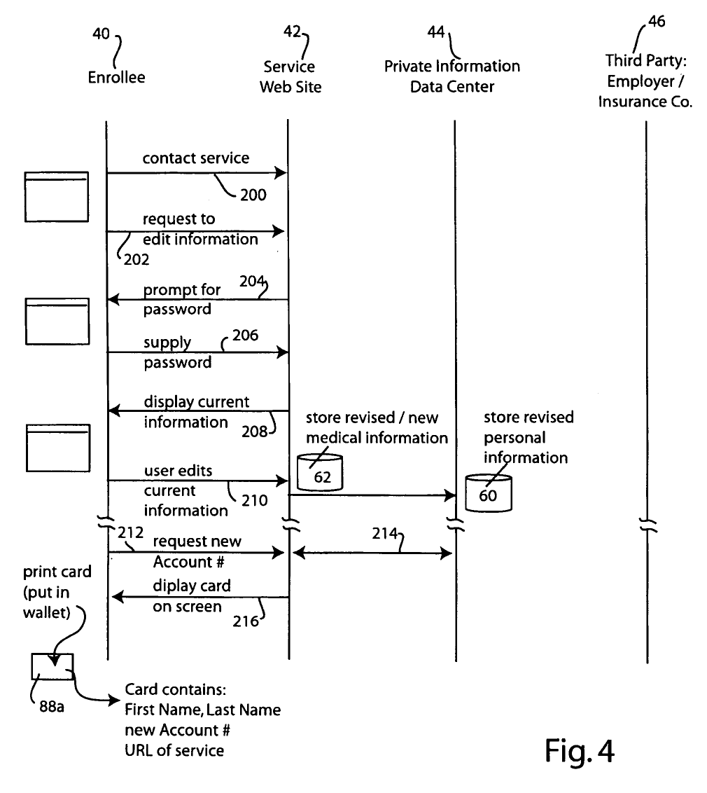

When an enrollee wishes to make changes to the information stored in the system, a special procedure is followed. This procedure is illustrated in FIG. 4. The enrollee 40 first contacts the service website 42 as at 200 and then sends a request to edit information as at 202. The enrollee is then prompted to supply his or her user-selected username and the password established in step 58 (FIG. 1). Specifically, the website 42 prompts the enrollee for the password at 204 and the enrollee supplies it at 206. If the supplied username and password match the data stored in the system, the service website publishes the current information on a web screen as at 208. The user is then allowed to edit that information as at 210. As with the information supplied during initial enrollment (FIG. 1) the server website automatically routes medical information to be stored in the medical information data store 62 and routes the enrollee's personal information to the data store 60 maintained at the private information data center 44.

A special case involves a situation where the enrollee's card or tag has been lost or stolen. In this instance, the enrollee may not wish to change any medical information or personal identity information stored within the database, but only wishes to have a new account number assigned. The process of FIG. 4 may be used for this purpose with only a slight modification. Instead of editing the enrollee's current information at step 210, the enrollee may request that a new account number be issued at step 212. This request causes the existing account number to be deleted or otherwise rendered inoperative, with the newly generated account number being supplied to the private information data center 44 as at 214. Therefore, the enrollee's existing medical information and personal information may be related using the new account number. The service website then displays a newly generated card on the enrollee's web screen as at 216, with the newly generated card 88a containing the enrollee's first name, last name, the newly issued account number and the URL of the service website.

In the embodiments illustrated so far, the medical information stored within the system is provided by the enrollee as answers to a series of questions presented at the enrollee's web browser. As discussed, there may be instances where the enrollee may not know a particular answer to a particular question (e.g., what is your blood type?) and the system thus includes an answer “I don't know.”

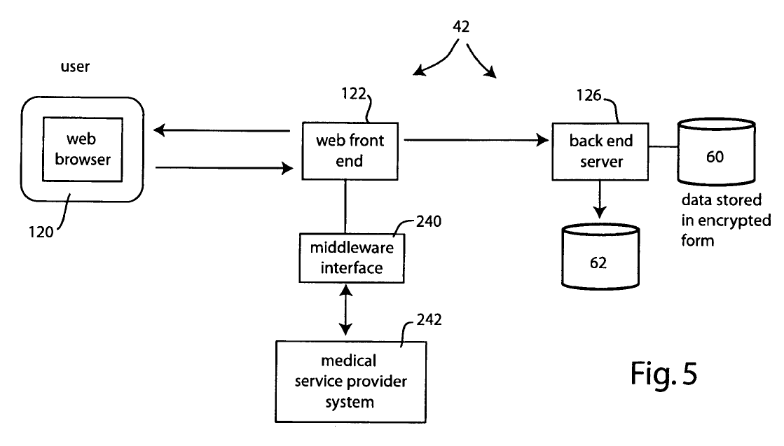

In an alternate embodiment illustrated in FIG. 5, the system further includes a middleware interface 240 by which the web front end is coupled to a medical service provider's system 242. The service provider's system can typically be maintained by a medical service provider, such as the enrollee's primary care physician. Information regarding the enrollee's medical history (e.g., the enrollee's blood type) is stored in that system. Although much of the information stored in a medical service provider's system is not suitable for consumption by the lay person, some basic information may be helpful in establishing a basic medical history for emergency purposes. The medical service provider system 242 can be configured to identify certain groups of information as being publishable for use by the medical information system. This identified information is transferred, upon request, through the middleware interface 240. The enrollee, at his or her web browser, is be able to query the supplied information in order to determine answers to questions that he or she may not otherwise know (e.g., the person's blood type). Alternatively, the medical service provider system 242 can be configured to automatically populate certain fields within the medical information data store 62. In such an embodiment, the person's medical data can automatically show up as part of his or her emergency medical information, without requiring the user to enter it.

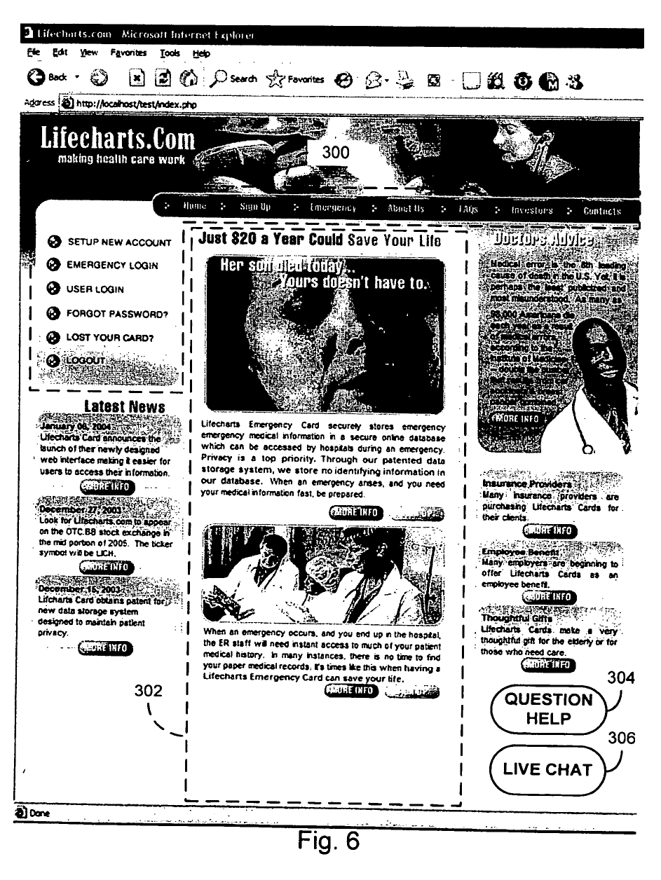

Turning now to FIGS. 6-45, a user interface according to the present invention has navigation components 300 and input/output components. The navigation components 300 permit a user to navigate between input/output components 302 that are intended for different types of users. Some examples of different types of users include prospective enrollees, enrollees, and medical personnel attempting to acquire recorded emergency medical information of one or more incapacitated enrollee patient. Thus, a user can interact with navigation components 300 to select navigation options such as “Home”, “Sign Up”, “Emergency”, “About Us”, “FAQs”, “Investors”, “Contacts”, “Set Up New Account”, “Emergency Login”, “Forgot Password?”, “Lost Your Card?”, and “Logout.”

Some additional user interface components can include a question help button 304 and a live chat button 306. The question help button 304 becomes active whenever the enrollee is prompted to answer a question or make a selection. The user can click on the question help button 304 to obtain additional instructions relating to the currently displayed question or selection. The live chat button 306 becomes active whenever online expert assistance is available. The user can click on the live chat button 306 to initiate a chat session with an expert trained to assist the user in answering questions, making selections, or generally employing the user interface in any respect.

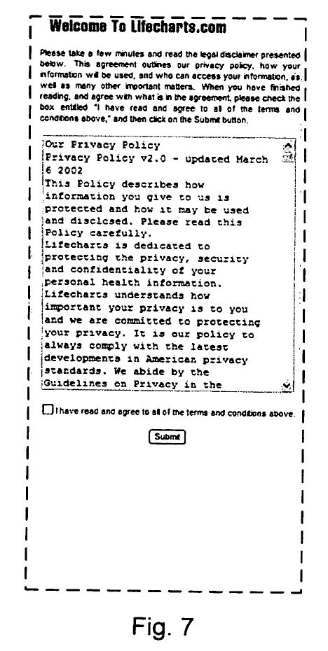

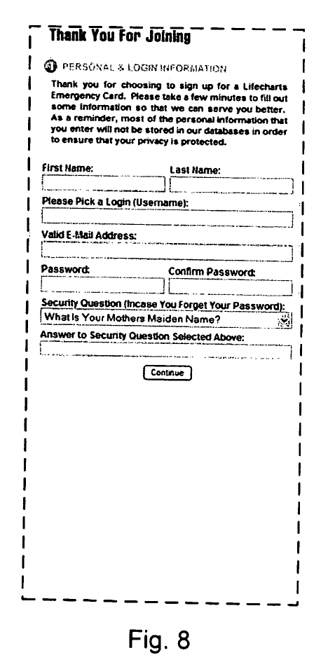

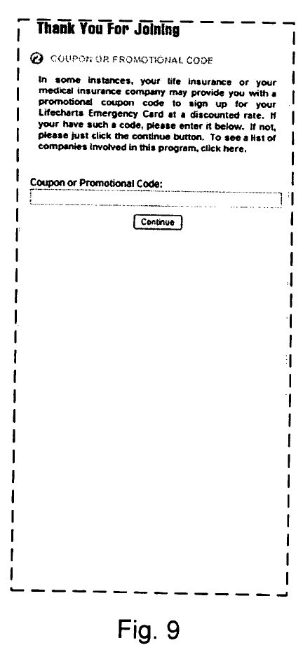

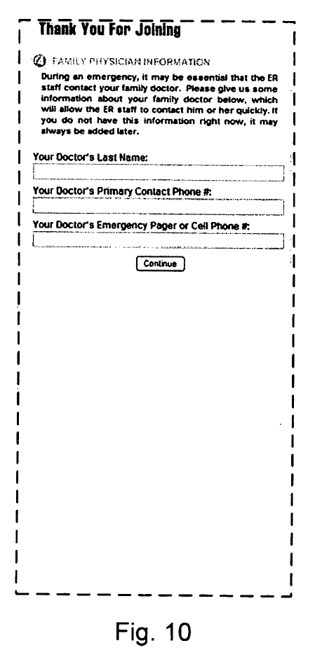

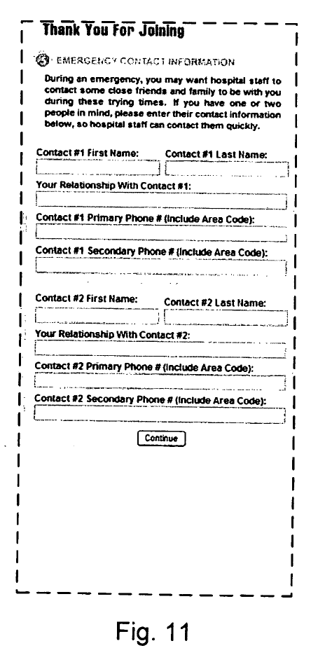

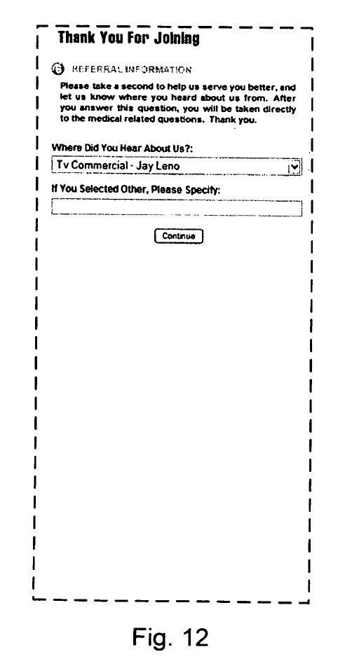

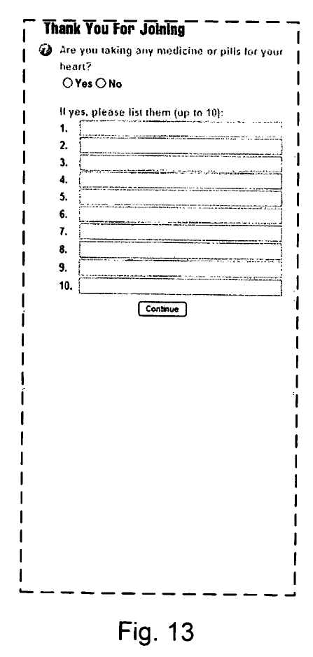

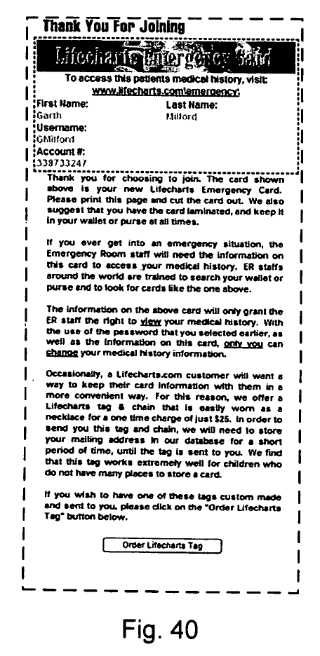

The particular input/output components 302 presented to a user thus vary depending at least partly on user selections of one or more of the navigation components 300. For example, a new enrollee selecting to “Setup New Account” is presented with input/output components in FIGS. 7-40. Accordingly, the enrollee is prompted to make selections (FIG. 7-FIG. 39) that accomplish several goals, and is presented with a printable card (FIG. 40) bearing the enrollees personal information, username, account number, and instructions to emergency medical personnel for accessing the enrollee's medical history. For example, a legal relationship is established between the enrollee and the party providing the emergency medical information storage and access service using a terms and conditions interface component (FIG. 7); this component explains the privacy policy in force and requires that the enrollee agree to the privacy policy before proceeding with enrollment. Also, enrollee personal information is gathered (FIG. 8), such as legal name, username, email address, password, and answers to security questions. Further, a promotional code can be entered (FIG. 9), such as might have been provided by an employer or insurance company that provides the enrollee's subscription. Yet further, referral information is requested (FIG. 12) to help the service provider track the effectiveness of advertising and identify new avenues of information dissemination. Further still, a patient history is taken (FIG. 10-11, FIG. 13-39), that employs prompts to acquire at least partly expertly constrained answers to questions in order to collect the type of high priority information needed by emergency personnel in an emergency situation.

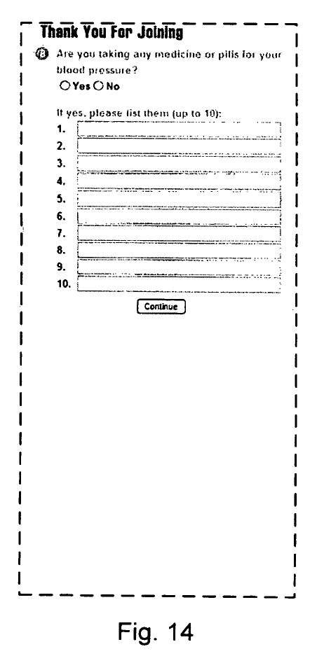

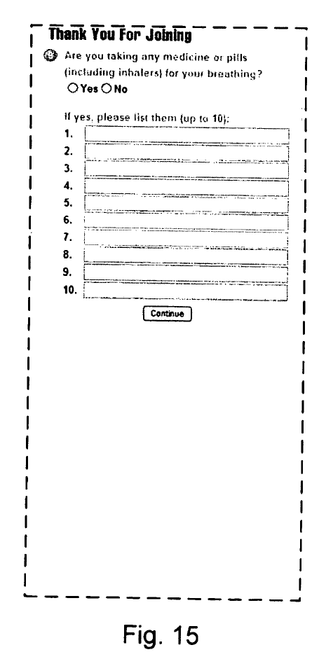

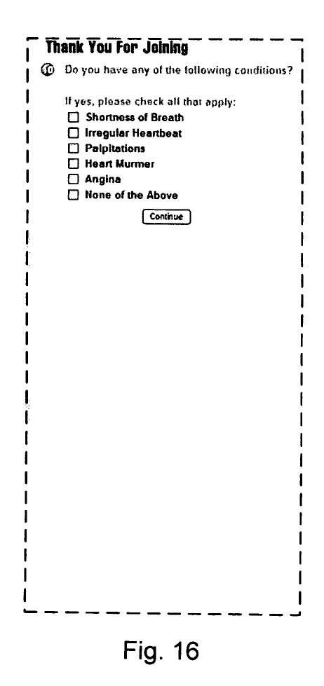

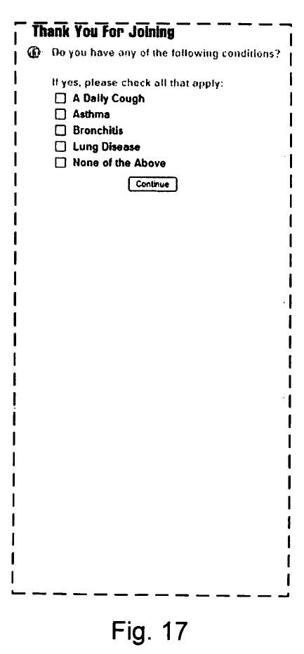

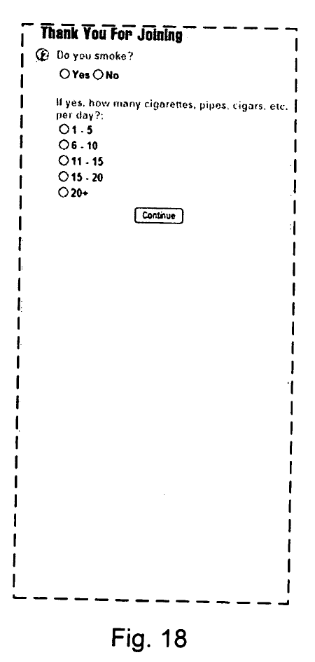

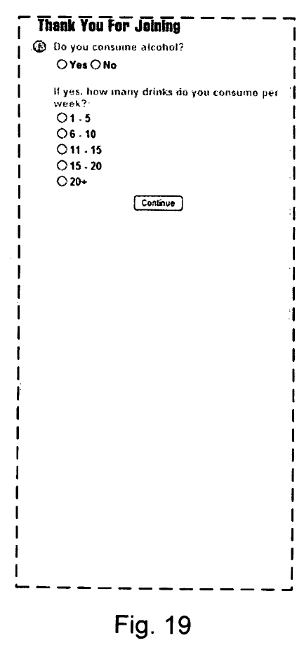

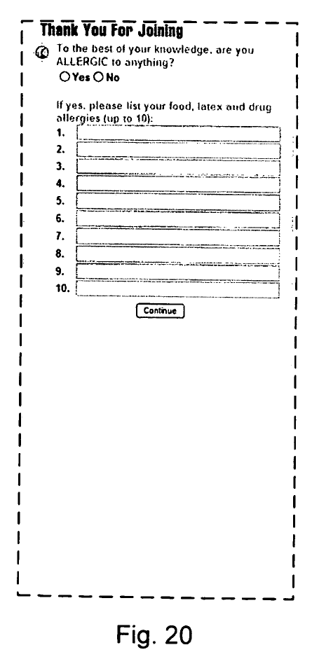

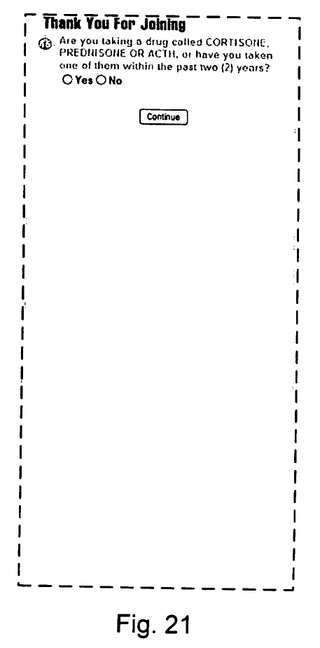

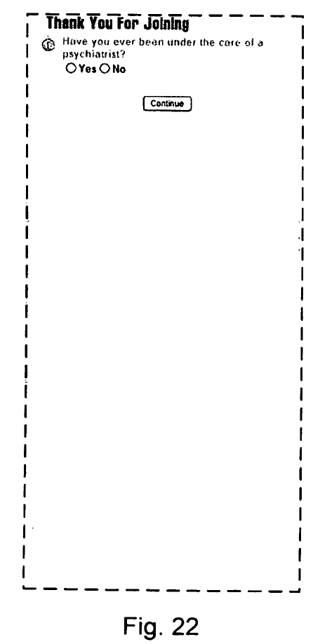

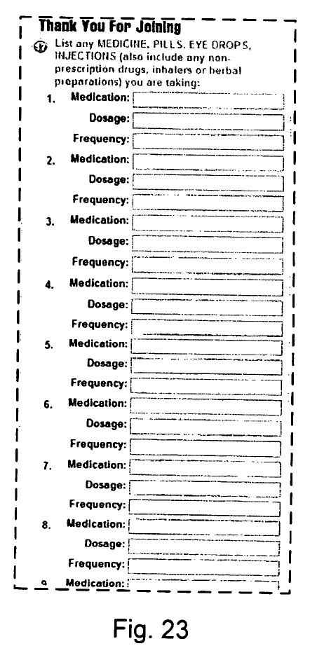

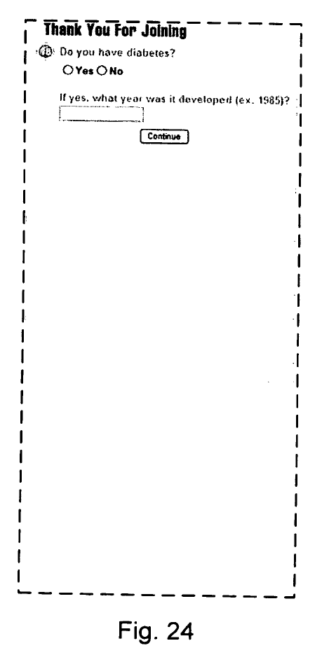

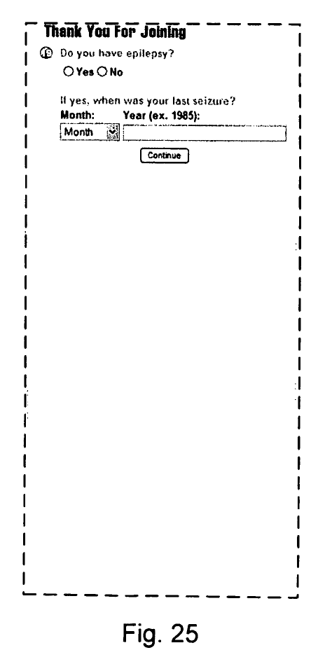

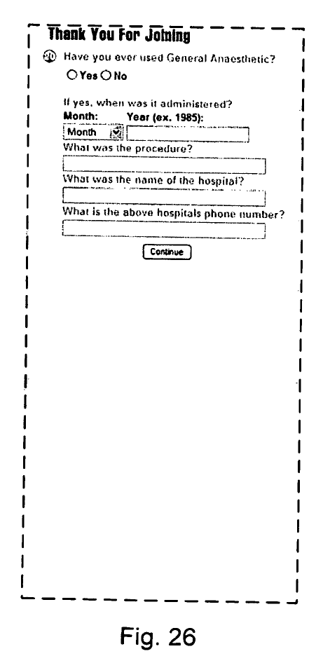

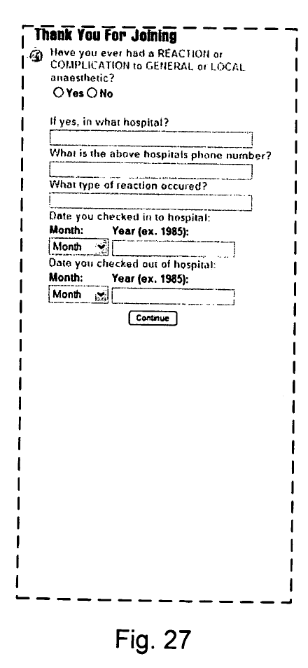

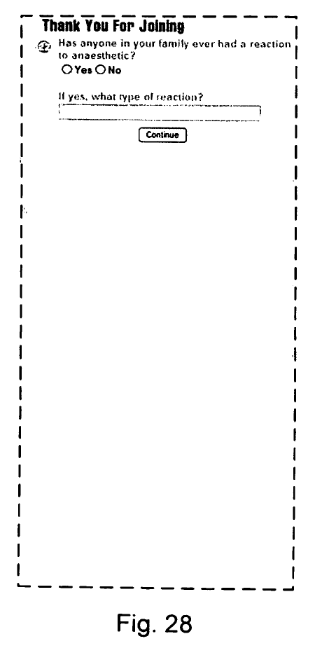

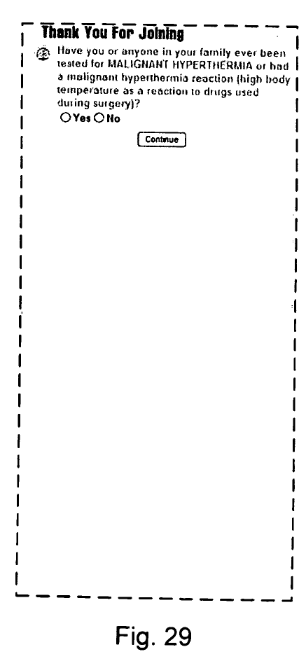

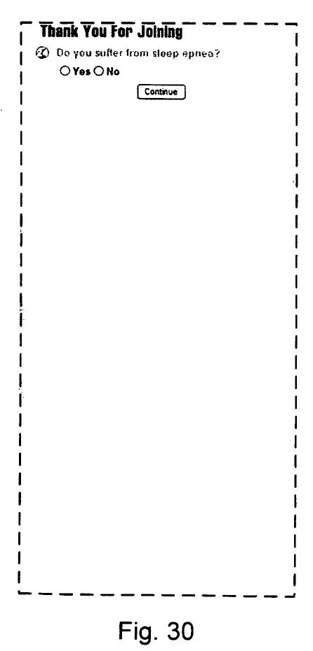

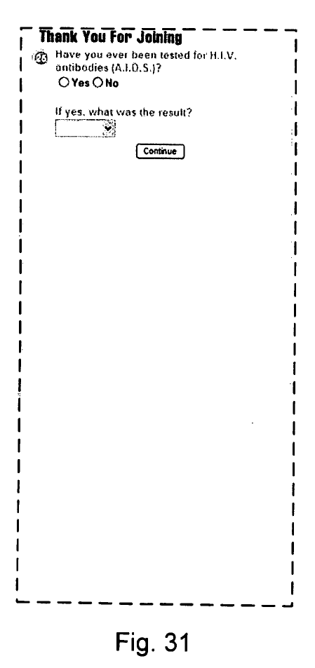

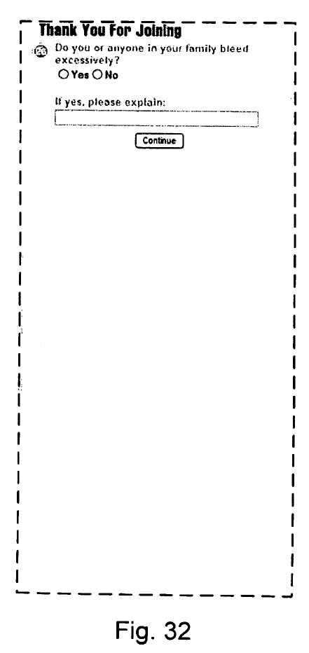

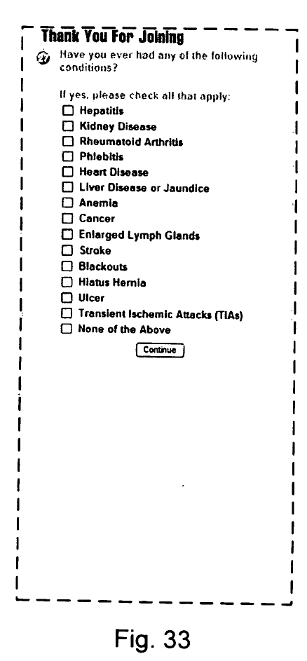

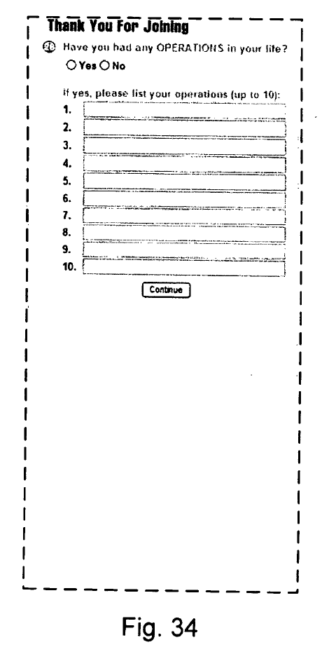

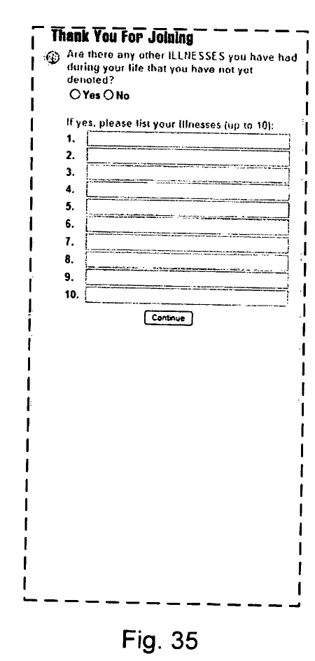

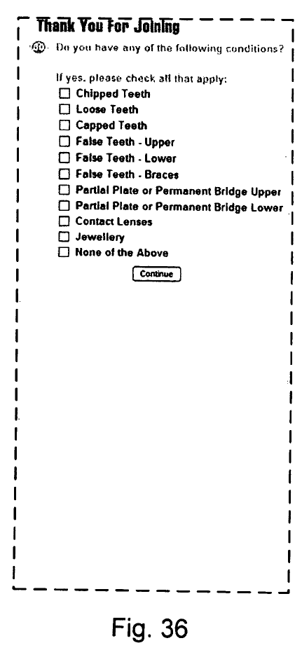

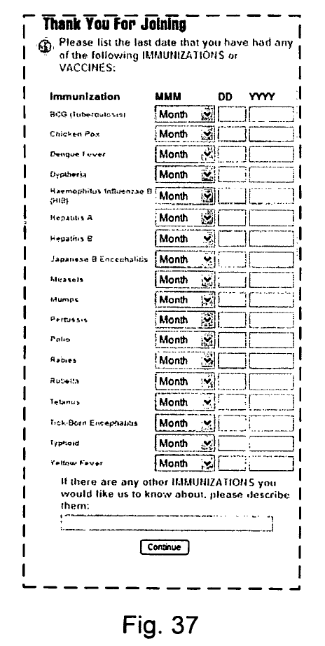

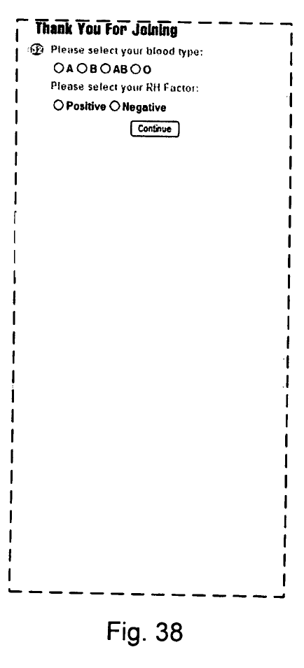

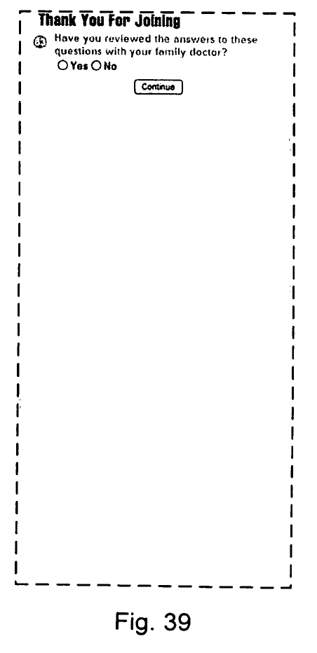

The taking of a patient history by the user interface attempts to acquire various types of information. Types of information collected include: family physician information (FIG. 10); emergency contact information (FIG. 11); medications being used for heart conditions (FIG. 13), blood pressure (FIG. 14), and breathing (FIG. 15); known enrollee symptomatic conditions relating to diagnosis of a heart condition (FIG. 16) and lung condition (FIG. 17); habits relating to smoking (FIG. 18) and alcohol consumption (FIG. 19); allergies (FIG. 20); past use of certain medications (FIG. 21) such as cortisone, prednisone, and acth within the past two years; past psychiatric care (FIG. 22); routinely used medications (FIG. 23); known health conditions such as diabetes (FIG. 24), epilepsy (FIG. 25), sleep apnea (FIG. 30); subjection to a general anesthetic and related procedures (FIG. 26); past anesthesia complications of the enrollee (FIG. 27) and the enrollee's family (FIG. 28); past personal or family manifestation of malignant hyperthermia (FIG. 29); last aids test (FIG. 31) and results; family history of excessive bleeding (FIG. 32); various diseases (FIG. 33); past surgical procedures (FIG. 34); past illnesses (FIG. 35); tooth conditions (FIG. 36); vaccines and immunizations (FIG. 37); and blood type and RH factor (FIG. 38). In addition, the enrollee is permitted to specify that the answers given have been confirmed with the family doctor (FIG. 39).

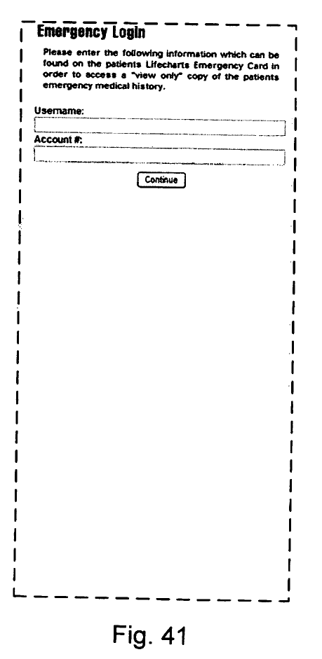

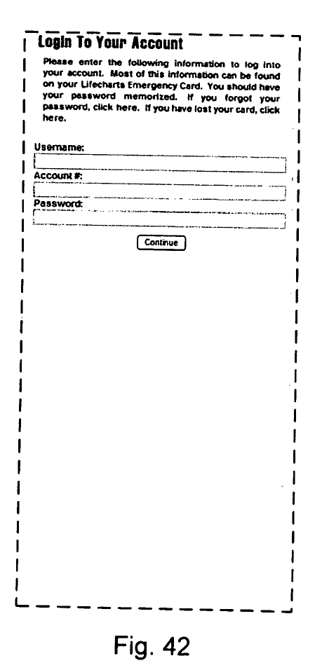

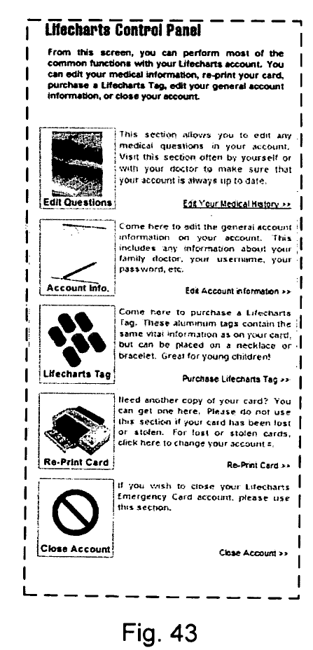

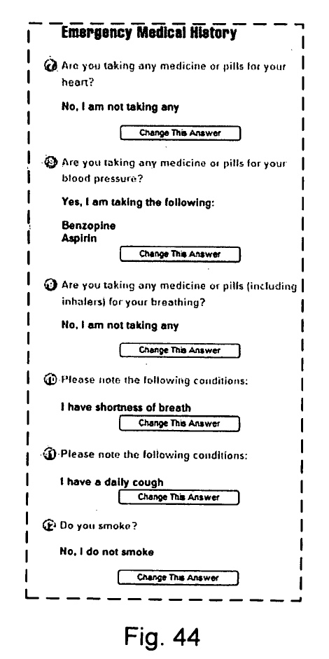

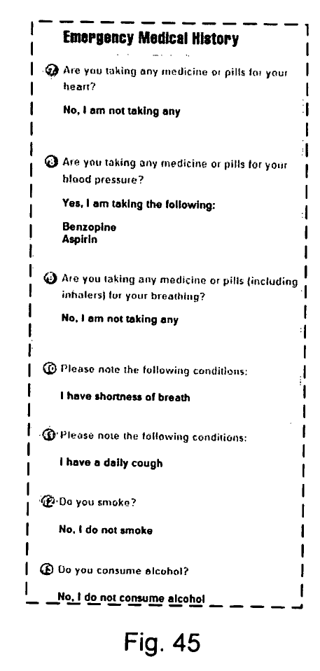

As stated above, the particular input/output components 302 presented to a user thus vary depending at least partly on user selections of one or more of the navigation components 300. For example, emergency medical personnel can select “Emergency Login” and provide the user name and account number on the enrollee's card (FIG. 41) to obtain a view of the enrollee's collected emergency medical information (FIG. 45). Also, a returning enrollee can select “user login” and provide the username, password, and account number (FIG. 42) to obtain an editable view of the enrollee's collected emergency medical information (FIG. 44). Returning enrollees can also access a control panel (FIG. 43) that allows the enrollee to edit questions, edit account information, order a wearable tag with the same information as the printable card, reprint the card, or close the account.

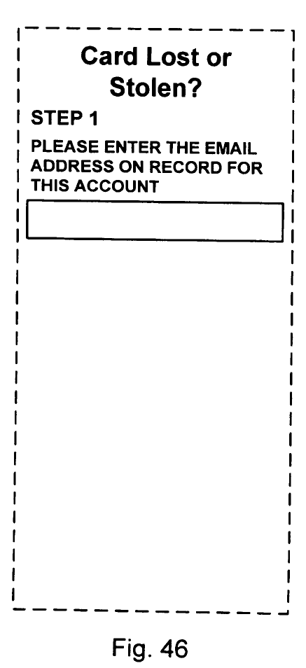

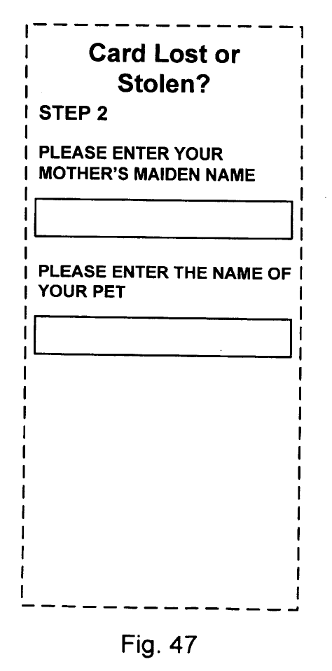

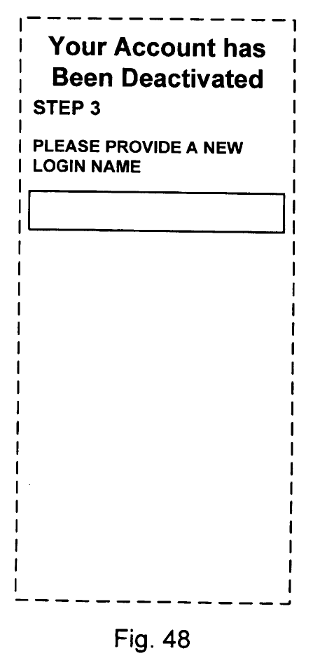

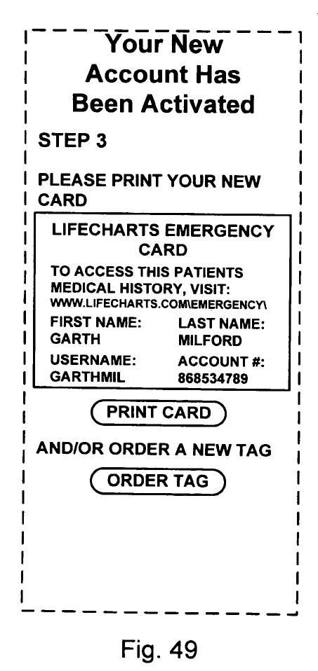

FIGS. 46-49 illustrate user interface components encountered by an enrollee reporting a lost or stolen card. At step 1 (FIG. 46), the enrollee is prompted to provide the email address associated with the account. This type of information is usually known to the enrollee, but not carried in the enrollee's wallet. If the email address is entered correctly, then the enrollee is prompted at step 2 (FIG. 47) to provide the answers to the enrollee's security questions. If these answers are entered correctly, then the old account number is deactivated and a new number assigned, and the enrollee is prompted at step 3 (FIG. 48) to supply a new user name. Finally, at step 4 (FIG. 49), the enrollee is presented with a new card to print and/or an opportunity to order a new tag.

The description of the invention is merely exemplary in nature and, thus, variations that do not depart from the gist of the invention are intended to be within the scope of the invention. For example, in some embodiments, an enrollee can specify a desire to receive scheduled reminder emails with links to the editable medical information. Also, some embodiments may use an expert system to acquire information updates in a focused manner especially for types of medical information that change frequently, such as prescription medications. Further, questions may be individually time and date stamped to indicate to emergency medical personnel a time of last update of the question by the enrollee. Further still, additional or alternative prompts may be employed by the user interface of the system.

Additional or alternative prompts by the user interface of the system can gather additional or alternative types of information. For example, it is envisioned that a question may be posed that prompts an enrollee to specify patient wishes regarding medical care in the absence of a living will. Specifically, the enrollee can be presented with a situation description, such as, “If I lose the ability to communicate concerning medical treatment decisions, or if I have any other incurable or irreversible mental or physical condition which seriously or totally disables me with NO REASONABLE EXPECTATION OF RECOVERY, I DO NOT want the medical staff to use any of the following to keep me alive.” Next, the enrollee can be prompted to indicate selections of undesired medical treatment, including: (a) surgery; (b) medication (except pain relief); (c) cardiopulmonary resuscitation; (d) antibiotics; (e) kidney dialysis; (f) blood transfusion; (g) radiation or chemotherapy; (h) a mechanical respirator; and (i) artificial airway maintenance by intubation, or tracheostomy. The aforementioned list is not intended to be exhaustive, and alternative or additional selections can be supplied. A note can accompany the prompt to indicate that the selections are not intended to replace a living will, but rather to provide guidance to family members or others with Power of Attorney in absence of a living will. Alternatively, a legally binding living will can be constructed, and/or individuals can be designated to make decisions on behalf of the enrollee if the enrollee is incapacitated.

A further prompt that can be employed is one designed to motivate the enrollee to compose a letter to loved ones to be delivered in the event of the enrollee's death. Then, when an account is cancelled, it can prompt for a reason of cancellation and deliver the letter if the answer to the prompt indicates the enrollee has died.

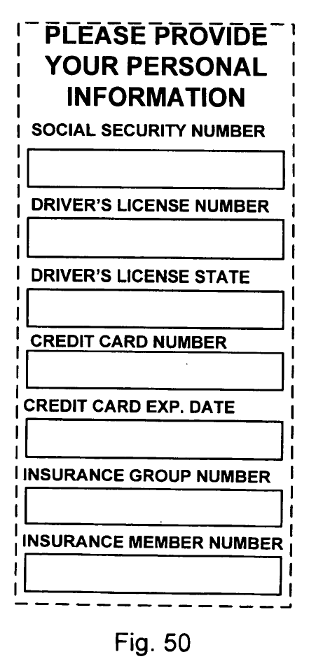

Moreover, the information storage system can be used to store alternative or additional types of information besides medical information, and even provide a system that stores all of the enrollee's information in one place. As illustrated in FIG. 50, types of information that can be gathered, stored, and accessed include social security number, driver's license information, credit card information, insurance information, and other types of information. This type of information can be useful to the enrollee, especially if the enrollee's wallet is lost or stolen, so that the enrollee can cancel credit cards and take other actions. However, access of some or all of this information may require passage of additional security measures, such as provision of the enrollee's email address and answers to the enrollee's security questions.

It is further envisioned that in some embodiments biometric features of the enrollee must be extracted, provided, and processed in real time in order to access any portion of the stored information, including emergency medical information. Suitable equipment can be installed in emergency rooms to facilitate the process of extracting the required features. Types of biometric features employed can be fingerprints, handprints, retinal patterns, facial features, signatures, lip movement, speech patterns, and others. Such variations are not to be regarded as a departure from the spirit and scope of the invention.

What is claimed is:

1. A medical information system, comprising:
a medical information web server;
a medical information data store that communicates with said web server;
the web server being configured to collect medical information from a user and to store said medical information in said medical information data store in association with an account number uniquely associated with said user;
the web server being configured to publish a printable web page to defining a card bearing: (a) indicia identifying said user, (b) the account number associated with said user, and (c) an internet address by which information stored in said medical information data store may be accessed by utilizing said account number.

2. The system of claim 1 further comprising:
a personal information data store that communicates with said web server; and wherein
the web server is configured to collect personal information from said user and to store said personal information in said personal information data store in association with said account number.

3. The system of claim 2 wherein said personal information data store and said medical information data store are maintained on separate servers.

4. The system of claim 1 wherein said web server is configured to mediate the creation of a user identification name and password that is separate from said account number and used by said web server to permit said user to edit medical information stored in said medical information data store.

5. The system of claim 1 wherein said web server is configured to establish encrypted communication with said user, whereby medical information supplied by the user is encrypted during transit over the internet.

6. The system of claim 1 wherein said medical information data store is configured to store medical information in an encrypted form.

7. The system of claim 2 wherein said web server is configured to establish encrypted communication with said user, whereby personal information supplied by the user is encrypted during transit over the internet.

8. The system of claim 2 wherein said personal information data store is configured to store medical information in an encrypted form.

9. The system of claim 1 further comprising middleware interface adapted for coupling to the medical information system of a medical service provider.

10. The system of claim 9 wherein said interface and said web server cooperate to obtain information from said medical information system of a medical service provider.

11. The system of claim 10 wherein said web server cooperate to obtain information from said medical information system of a medical service provider in response to a request by said user through access to said web server using a web browser.

12. The system of claim 10 wherein said web server cooperate to obtain information from said medical information system of a medical service provider automatically.

13. The system of claim 1 wherein said web server provides an interface to a third party that supplies said account number to said third party.

14. The system of claim 13 wherein said third party is a provider of medical insurance.

15. The system of claim 13 wherein said third party is an employer associated with said user.

16. The system of claim 1 wherein said web server includes ordering mechanism whereby the user requests delivery of a physical tag bearing: (a) indicia identifying said user, (b) the account number associated with said user, and (c) an internet address by which information stored in said medical information data store may be accessed by utilizing said account number.

17. The system of claim 1 wherein said web server includes mechanism whereby a third party can produce a printed matter containing said account number associated with said user.

18. The system of claim 17 wherein said printed matter is an in insurance card.

19. The system of claim 17 wherein said printed matter is an employee identification card.

20. A method of providing medical information, comprising:
storing medical information associated with said user in association with an account number;
providing said user with information via the internet from which a printable card bearing system access information may be produced; and
providing an interface via the internet at which said medical information may be accessed by using said system access information.

21. The method of claim 20 wherein said system access information includes an account number that is unique to said user.

22. The method of claim 20 further comprising providing said user with information from which a printable card bearing the following information may be produced:
(a) indicia identifying said user, (b) said account number associated with said user, and (c) an internet address by which information stored in said medical information data store may be accessed by utilizing said account number.

23. The method of claim 20 further comprising:
obtaining said medical information from said user by publishing questions via the internet to which said user responds and from which said medical information is extracted.

24. The method of claim 20 further comprising storing personal information associated with said user in association with said account number in a data store separate from the data store in which said medical information is stored.

25. The method of claim 20 further comprising, mediating the creation of a user identification name and password that is separate from said account number for use in permitting said user to edit said medical information.

26. The method of claim 20 further comprising encrypting said medical information.

27. The method of claim 24 further comprising encrypting said personal information.

28. The method of claim 23 further comprising encrypting said information obtained from said user prior to sending it to a data store to be stored.

29. The method of claim 23 further comprising providing said account number to a third party for reproducing onto printed matter associated with said third party.

30. The method of claim 20 further comprising providing a second interface via the internet for communicating with an information system associated with a medical service provider and usable to develop at least a portion of said medical information.
